(19) United States
(12) Patent Application Publication
(10) Pub. No.: US 2011/0264993 A1
(43) Pub. Date: Oct. 27, 2011

(54) Multi-Threaded Sort of Data Items in Spreadsheet Tables

(75) Inventors: Weng Keong Peter Anthony Leong, Redmond, WA (US); Chad B. Rothschiller, Edmonds, WA (US); Su-Piao Wu, Sammamish, WA (US); Ross G. Bierbryer, New York, NY (US)

(73) Assignee: MICROSOFT CORPORATION, Redmond, WA (US)

(21) Appl. No.: 12/766,629

(22) Filed: Apr. 23, 2010

(51) Int. Cl. G06F 17/00; G06F 9/46

(52) U.S. Cl. 715/217; 715/212; 718/102

(57) ABSTRACT

To perform a sort operation on a spreadsheet table, data items in the spreadsheet table are divided into a plurality of blocks. Multiple threads are then used to sort the data items in the blocks. After the data items in the blocks are sorted, multiple threads are used to merge the blocks into a final block. The final block contains each of the data items in the spreadsheet table. A sorted version of the spreadsheet table is then displayed. Data items in the sorted version of the spreadsheet table have the same order as an order of data items in the final block.

### BACKGROUND

Spreadsheet applications enable users to view and manipulate tabular data. For example, a spreadsheet application can enable a user to view and manipulate a spreadsheet table containing rows for different products and columns for different warehouses. In this example, the cells contain values indicating inventories of the products at the warehouses. In many cases, users want to be able to sort the rows in spreadsheet tables. Continuing the previous example, the user may want to sort the rows in the spreadsheet table based on how much a certain warehouse contains of each of the products. In other cases, users want to be able to sort the columns in spreadsheet tables. Continuing the previous example, the user may want to sort the columns in the spreadsheet table based on how much of a certain product is in each of the warehouses.

In large spreadsheet tables, the process of sorting rows in a spreadsheet table can be relatively slow. Such processing delays can disrupt a user's train of thought or discourage the user from sorting the rows in a spreadsheet table. Consequently, it is desirable to make the process of sorting rows in a spreadsheet table as quick as possible.

### SUMMARY

A computing system divides data items in a spreadsheet table into a plurality of blocks. Multiple threads are then used to sort the data items in each of the blocks. After the data items in the blocks are sorted, multiple threads merge the blocks into a final block. A sorted version of the spreadsheet table is then displayed. The data items in the sorted version of the spreadsheet table have the same order as the data items in the final block.

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating an example computing system.

FIG. 2 is a block diagram illustrating an example alternate embodiment of the computing system.

FIG. 3 is a flowchart illustrating an example operation to sort a spreadsheet table.

FIG. 4 is a flowchart illustrating an example operation performed by a block sorting thread to sort one or more blocks.

FIG. 5 is a flowchart illustrating an example operation performed by a min merge thread to insert the smallest remaining rows in a set of sorted blocks into a final block.

FIG. 6 is a flowchart illustrating an example operation performed by a max merge thread to insert the largest remaining rows in the set of sorted blocks into the final block.

FIG. 7 is a block diagram illustrating an example computing device.

### DETAILED DESCRIPTION

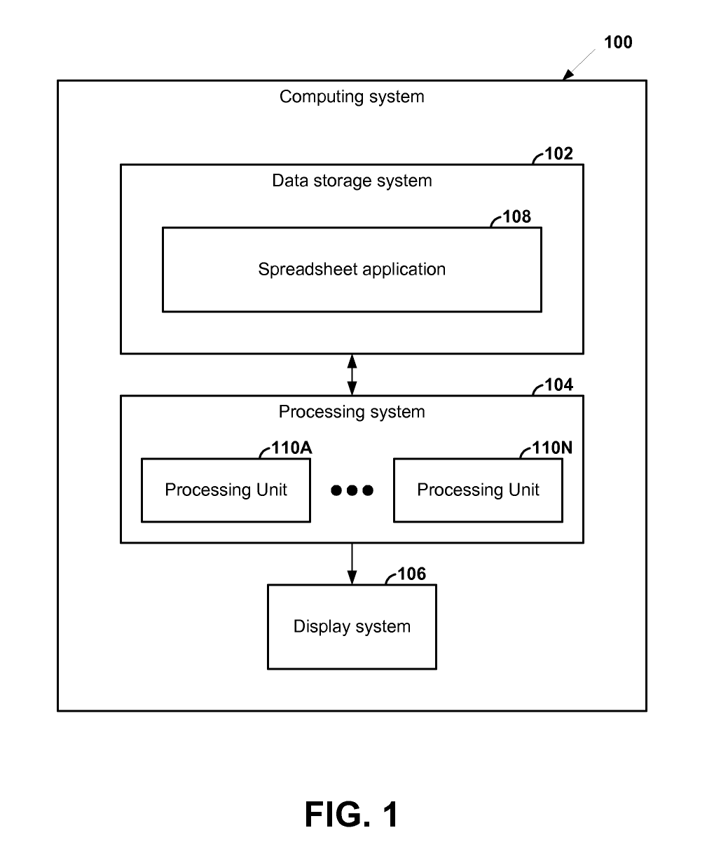

FIG. 1 is a block diagram illustrating an example computing system 100. The computing system 100 is a system comprising one or more computing devices. A computing device is a physical, tangible device that processes information. In various embodiments, the computing system 100 comprises various types of computing devices. For example, the computing system 100 can comprise one or more desktop computers, laptop computers, netbook computers, handheld computing devices, smartphones, standalone server devices, blade server devices, mainframe computers, supercomputers, and/or other types of computing devices. In embodiments where the computing system 100 comprises more than one computing device, the computing devices in the computing system 100 can be distributed across various locations and communicate via a communications network, such as the Internet or a local area network.

As illustrated in the example of FIG. 1, the computing system 100 comprises a data storage system 102, a processing system 104, and a display system 106. It should be appreciated that in other embodiments, the computing system 100 includes more or fewer components than are illustrated in the example of FIG. 1. Moreover, it should be appreciated that FIG. 1 shows the computing system 100 in a simplified form for ease of comprehension.

The data storage system 102 is a system comprising one or more computer-readable data storage media. A computer-readable data storage medium is a physical device or article of manufacture that is capable of storing data in a volatile or non-volatile way. In some embodiments, the data storage system 102 comprises one or more computer-readable data storage media that are non-transient. Example types of computer-readable data storage media include random access memory (RAM), read-only memory (ROM), optical discs (e.g., CD-ROMs, DVDs, BluRay discs, HDDVD discs, etc.), magnetic disks (e.g., hard disk drives, floppy disks, etc.), solid state memory devices (e.g., flash memory drives), EEPROMS, field programmable gate arrays, and so on. In some embodiments where the data storage system 102 comprises more than one computer-readable data storage medium, the computer-readable data storage media are distributed across various geographical locations.

The data storage system 102 stores computer-readable instructions representing a spreadsheet application 108. In some embodiments where the data storage system 102 comprises more than one computer-readable data storage medium, the computer-readable instructions representing the spreadsheet application 108 are distributed across two or more of the computer-readable data storage media. In other embodiments where the data storage system 102 comprises more than one computer-readable data storage medium, the computer-readable instructions representing the spreadsheet application 108 are stored on only one of the computer-readable data storage media.

The processing system 104 is a system comprising a plurality of processing units 110A through 110N (collectively, “the processing units 110”). In various embodiments, the processing system 104 comprises various numbers of processing units. For example, the processing system 104 can comprises one, two, four, eight, sixteen, thirty-two, sixty-four, or other numbers of processing units. Each of the processing units 110 is a physical integrated circuit. Each of the processing units 110 is capable of executing computer-readable instructions asynchronously from the other ones of the processing units 110. As a result, the processing units 110 can independently execute computer-readable instructions in parallel with one another.

The display system 106 is a system used by the processing system 104 to display information to a user. In various embodiments, the display system 106 displays information to a user in various ways. For example, in some embodiments, the display system 106 comprises a graphics interface and a monitor.

The processing units 110 in the processing system 104 execute the instructions that represent the spreadsheet application 108. The instructions that represent the spreadsheet application 108, when executed by the processing units 110, cause the computing system 100 to provide the spreadsheet application 108. The spreadsheet application 108 enables a user to view and manipulate spreadsheet tables. A spreadsheet table is a set of data that is organized as a table having one or more rows and one or more columns. The tabular data can represent various types of data. For example, the tabular data can be sales data, inventory data, military data, billing data, statistical data, population data, demographic data, financial data, medical data, sports data, scientific data, or any other type of sortable data that can be presented in a table.

Cells in a spreadsheet table can contain values having various data types. For example, the values in cells can be integer numbers, real numbers, floating point numbers, alphanumeric text strings, dates, monetary amounts, Boolean values, and so on. In addition to the values in the cells, each of the cells can have a variety of other properties. For example, each of the cells can have a background color property, a font color property, one or more flag properties, a visibility property, a font style property, a font size property, and so on.

The spreadsheet application 108 is able to use multiple threads to perform a sort process on a spreadsheet table. The sort process can be performed on rows or columns of the spreadsheet table. For ease of explanation, this document discusses performing the sort operation on rows of the spreadsheet table. However, it should be appreciated that, unless otherwise indicated, discussion in this document of rows is equally applicable with respect to columns. The term “data item” is used in this document to refer generically to either a row or a column.

The sort process sorts the rows in the spreadsheet table. In various instances, the spreadsheet table can be a complete table in a spreadsheet, a portion of a table, a pivot table, or another type of spreadsheet table. Furthermore, in some embodiments, a user of the spreadsheet application 108 selects the spreadsheet table.

Sorting rows in the spreadsheet table comprises manipulating an order of the rows in the spreadsheet table such that the rows in the spreadsheet table are properly ordered. The rows in the spreadsheet table are properly ordered when the rows are properly ordered for each sort-by column. A sort-by column is a column in the spreadsheet table on which rows are sorted. In a sort operation on columns, the columns in the spreadsheet table are properly ordered when the columns are properly ordered for each sort-by row. The term “sort-by line” is used in this document to refer generically to a sort-by column or a sort-by row.

Each sort-by column has sorting requirements. The sorting requirements include a relevant property and an ordering relationship. The relevant property can be a variety of different properties of cells in the sort-by column. For example, the relevant property can be the values in the cells, the color of the cells, flags on the cells, colors of fonts in the cells, styles of fonts in the cells, size of fonts in the cells, hidden/visible status of the cells, and other properties of the cells.

An ordering relationship is a set of one or more rules that define how properties are ordered. Example types of ordering relationships include alphabetical ordering, reverse alphabetical ordering, numerical ordering, reverse numerical ordering, chronological ordering, reverse chronological ordering, categorical ordering, geographical ordering, and other types of orderings. As one particular example of a categorical ordering, an ordering relationship may define an ordering over Boolean values by indicating that all true values come before any false values. In another example, an ordering relationship may define an ordering over cell colors by indicating that blue cells come before green cells, yellow cells come before blue cells, red cells come before yellow cells, and so on. In some embodiments, a user of the spreadsheet application 108 is able to select the sort-by columns and the relevant properties and ordering relationships for the sort-by columns.

When there are multiple sort-by columns, the sort-by columns are ranked. The rows in the spreadsheet table are sorted first according to the sorting requirements of highest ranked sort-by column, then according to the sorting requirements of the second-highest ranked sort-by column, and so on. In other words, the rows are properly ordered for a given sort-by column when, for any two rows having the same relevant properties in cells of each higher-ranked sort-by column, the two rows satisfy the sorting requirements of the given sort-by column. The two rows satisfy the sorting requirements of the given sort-by column when an ordering relationship for the given sort-by column holds true for the relevant property of the two cells.

As described in detail elsewhere in this document, the sort process divides the rows in the spreadsheet table into a plurality of blocks. A block is a set of rows. After the rows are divided into blocks, the sort process enters a block sorting phase. During the block sorting phase, separate block sorting threads operate to sort rows in each of the blocks. The block sorting threads can execute concurrently on multiple ones of the processing units 110. A thread is a portion of a program that can run independently of and concurrently with other portions of the program.

After the block sorting threads sort the rows in each of the blocks, the sort process enters a merging phase. During the merging phase, the spreadsheet application 108 uses multiple threads to merge the sorted blocks into a final block. The final block contains each of the rows in the spreadsheet table. The rows in the final block are properly ordered.

In some embodiments, the spreadsheet table can include hidden rows. A hidden row is a row that is in the spreadsheet table, but is not visible to a user of the spreadsheet application 108. The user can choose to hide particular rows in order to simplify the appearance of the spreadsheet table. In such embodiments, the sort process sorts hidden as well as visible rows in the spreadsheet table.

After the sorted blocks are merged into the final block, the spreadsheet application 108 outputs result data for presentation to a user of the spreadsheet application 108. The result data is dependent on an order of the rows in the final block. In various embodiments, the spreadsheet application 108 outputs various types of data based on the final block. For example, in some embodiments, the spreadsheet application 108 outputs a sorted version of the spreadsheet table in which rows in the spreadsheet table have the same order as an order of the rows in the final block. Furthermore, in some embodiments, the spreadsheet application 108 generates and displays a report showing at least some rows in the sorted spreadsheet table. Furthermore, in some embodiments, the result data does not necessarily need to include all of the rows in the spreadsheet table. In instances where the result data is consumed by another process or subsets of the spreadsheet table are subject to further sorting, the result data is not necessarily presented to a user.

In some embodiments, the multi-threaded sort process described in this document can be significantly faster than a sort process that does not use multiple threads. For example, in some embodiments, the theoretical speedup factor of the multi-threaded sort process is 1/(sp/t+mp/2+r), where sp is the percentage of work in the multi-threaded sort process occurring in the block sorting phase, where t is the number of block sorting threads, where mp is the percentage of work in the multi-threaded sort process occurring in the merge phase, and r is the remaining percentage of work in the multi-threaded sort process. For example, where sp=26%, t=4, mp=43%, r=31%, the theoretical speedup factor is 169%. In another example, where sp=26%, t=2, mp=43%, r=31%, the theoretical speedup factor is 153%. A theoretical speedup factor for a given number of threads is a ratio of the execution time of a sequential algorithm divided by the execution time of a parallel algorithm with the given number of threads. In practice, the observed speedup factor of the multi-threaded sort process can be less than this theoretical speedup factor.

The following example describes the observed performance of the multi-threaded sort process on a particular computing system. It should be appreciated that the times and percentages cited in this example are for a particular computing system and vary in different embodiments and when performed on different computing systems. In this example, the cited times and speedup factors include time consumed during the sort phase and the merge phase of the multi-threaded sort process plus additional time consumed during the multi-threaded sort process. Such additional time can include time consumed updating cells and rendering the spreadsheet table for view. In this example, the time consumed during the sort phase and the merge phase is approximately 69% of the time consumed during the entire multi-threaded sort process. In this example, where there are four processing units in the processing system 104, the sort process is performed in 0.76 seconds on a spreadsheet table that has 10⁶ rows, as compared 1.19 seconds when the processing system 104 only includes a single processing unit, resulting in an observed speedup factor of approximately 156%. In this example, where there are four processing units in the processing system 104, the sort process is performed in 0.075 seconds on a spreadsheet table that has 10⁵ rows, as compared to 0.108 seconds when the processing system 104 only includes a single processing unit, resulting in an observed speedup factor of approximately 144%. In this example, where there are four processing units in the processing system 104, the sort process is performed in 0.012 seconds on a spreadsheet table that has 10⁴ rows, as compared to 0.015 seconds when the processing system 104 only includes a single processing unit, resulting in an observed speedup factor of approximately 122%. In this example, where there are two processing units in the processing system 104, the sort process is performed in 0.82 seconds on a spreadsheet table that has 10⁶ rows, as compared to 1.19 seconds when the processing system 104 only includes a single processing unit, resulting in an observed speedup factor of approximately 144%. In this example, where there are two processing units in the processing system 104, the sort process is performed in 0.079 seconds on a spreadsheet table that has 10⁵ rows, as compared to 0.112 seconds when the processing system 104 only includes a single processing unit, resulting in an observed speedup factor of approximately 142%. In this example, where there are two processing units in the processing system 104, the sort process is performed in 0.012 seconds on a spreadsheet table that has 10⁴ rows, as compared to 0.015 seconds when the processing system 104 only includes a single processing unit, resulting in an observed speedup factor of approximately 122% on spreadsheet tables having 10⁴ rows.

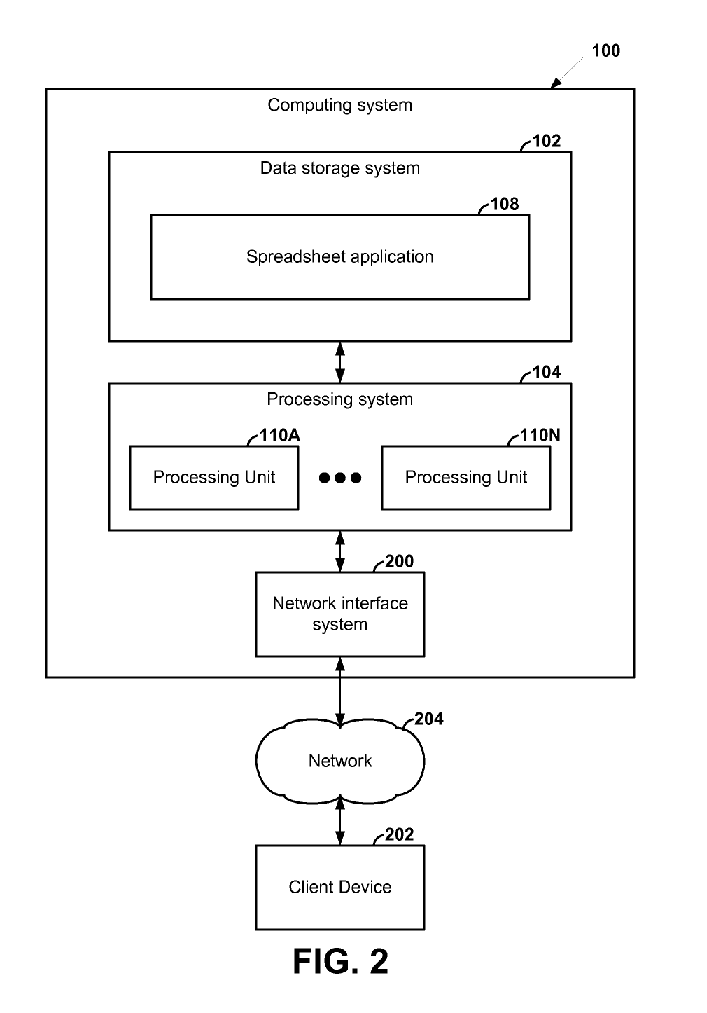

FIG. 2 is a block diagram illustrating an example alternate embodiment of the computing system 100. As illustrated in the example of FIG. 2, the computing system 100 comprises the data storage system 102 and the processing system 104, like in the example embodiment illustrated in FIG. 1. However, unlike the example embodiment illustrated in FIG. 1, the example alternate embodiment of the computing system 100 illustrated in FIG. 2, has a network interface 200 instead of the display system 106.

The network interface system 200 enables the computing system 100 to send and receive data from a client device 202 via a network 204. The network 204 is a communications network. The network 204 is a collection of computing devices and links that facilitate communication among the computing system 100 and the client device 202. In various embodiments, the network 204 includes various types of computing devices. For example, the network 204 can include routers, switches, mobile access points, bridges, hubs, intrusion detection devices, storage devices, standalone server devices, blade server devices, sensors, desktop computers, firewall devices, laptop computers, handheld computers, mobile telephones, and other types of computing devices. In various embodiments, the network 204 includes various types of links. For example, the network 204 can include wired and/or wireless links. Furthermore, in various embodiments, the network 204 is implemented at various scales. For example, the network 204 can be implemented as one or more local area networks (LANs), metropolitan area networks, subnets, wide area networks (such as the Internet), or can be implemented at another scale.

The client device 202 is a computing device. For example, the client device 202 can be a personal computer used by a user. The user uses the client device 202 to send requests to the computing system 100 and receive information from the computing system 100 via the network 204. In this way, the user can use the client device 202 to view and manipulate tabular data using the spreadsheet application 108. For example, the computing system 100 can send result data to the client device 202 via the network 204. In this example, the client device 202 is configured to process the result data for presentation to a user of the client device 202. For instance, the client device 202 can render a web page containing the result data or interact with a client application to display the result data.

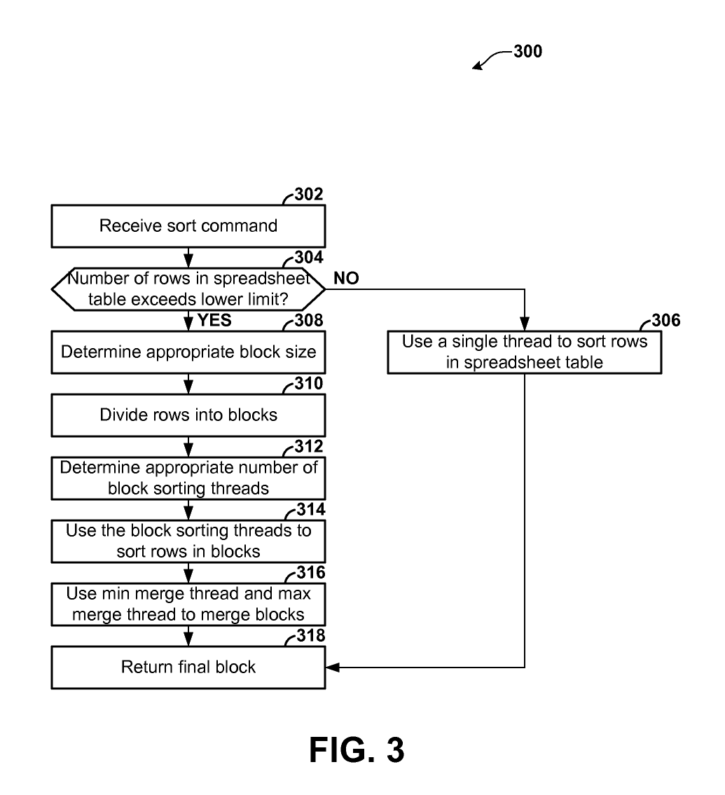

FIG. 3 is a flowchart illustrating an example operation 300 to sort a spreadsheet table. As illustrated in the example of FIG. 3, the operation 300 begins when the spreadsheet application 108 receives a sort command (302). The sort command instructs the spreadsheet application 108 to start a sort process on a particular spreadsheet table. Furthermore, the sort command can specify one or more sort-by columns, a relevant property for each of the sort-by columns, and an ordering relationship for each of the sort-by columns. In some embodiments, a user of the spreadsheet application 108 can specify the spreadsheet table, the one or more sort-by columns, the relevant properties, and/or the ordering relationships.

In various embodiments, the spreadsheet application 108 receives the sort command in various ways. For example, in some embodiments, the spreadsheet application 108 receives the sort command when a user of the spreadsheet application selects a particular user interface control of the spreadsheet application 108. Furthermore, in some embodiments, the spreadsheet application 108 receives the sort command when a user enters a particular keyboard command. Furthermore, in some embodiments, the spreadsheet application 108 receives the sort command from another process, thread, or application operating on the computing system 100, the client device 202, or another computing device.

Furthermore, in some embodiments, the spreadsheet application 108 begins the operation 300 without receiving an explicit sort command from a user or another process, thread, or application. For example, in some embodiments, the spreadsheet application 108 can begin the operation 300 automatically on a periodic basis or based on a schedule. Furthermore, in some embodiments, the spreadsheet application 108 can begin the operation 300 automatically when a user updates one or more rows in the spreadsheet table. Furthermore, in some embodiments, the spreadsheet application 108 begins the operation 300 automatically in response to detecting or receiving an event indicating that a change has occurred in a data source from which the spreadsheet table is drawn.

In response to receiving a sort command or otherwise receiving an indication to begin a sort process on a spreadsheet table, the spreadsheet application 108 determines whether the total number of rows in the spreadsheet table exceeds a lower limit (304). In various embodiments, the lower limit has various values. For example, in some embodiments, the lower limit is 255. In other embodiments, the lower limit is greater than 255 or less than 255. In some embodiments, the spreadsheet application 108 presents a user interface that allows an administrative user to set the lower limit. The administrative user can be the user who receives the result data or another user.

If the number of rows in the spreadsheet table does not exceed the lower limit (“NO” of 304), the spreadsheet application 108 uses a single thread to sort the rows in the spreadsheet table (306). In other words, the single thread generates a final block that contains each of the rows in the spreadsheet table. The rows in the final block are properly ordered. Using a single thread to sort the rows can be more efficient than using multiple threads to sort the rows when the number of rows is relatively low. This is because there can be computational penalties (e.g., delays) associated with starting or waking threads. Such computational penalties may only be worth incurring when there are a sufficient number of rows.

If the number of rows in the spreadsheet table exceeds the lower limit (“YES” of 304), the spreadsheet application 108 determines an appropriate block size (308). The appropriate block size is the maximum number of rows that a block is allowed to contain. In various embodiments, the spreadsheet application 108 determines the appropriate block size in various ways. For example, in some embodiments, the spreadsheet application 108 determines that the appropriate block size based on a number of rows in the spreadsheet table. For instance, in this example, the spreadsheet application 108 determines that the appropriate block size is a first block size (e.g., 128 rows) when the total number of rows in the spreadsheet table is greater than or equal to a first threshold (e.g., 257) and less than or equal to a second threshold (e.g., 16,384). In this example, the spreadsheet application 108 determines that the appropriate block size is a second block size (e.g., 1024 rows) when the total number of rows in the spreadsheet table is greater than the second threshold. The second block size is greater than the first block size. In other embodiments, the spreadsheet application 108 can determine the appropriate block size in a similar way using different block sizes and threshold numbers. Furthermore, in some embodiments, more than two thresholds can be used. Furthermore, in some embodiments, the spreadsheet application 108 presents a user interface that enables an administrative user to select the appropriate block size or criteria for determining the appropriate block size. The administrative user can be the user who receives the result data or another user.

Next, the spreadsheet application 108 divides the rows in the spreadsheet table into a set of blocks (310). None of the blocks contain more rows than the appropriate block size. In instances where the number of rows is not evenly divisible by the appropriate block size, one of the blocks is allowed to contain fewer rows than the appropriate block size. For example, if there are 300 rows in the spreadsheet table and the appropriate block size is 128 rows, there would be two blocks containing 128 rows apiece and one block containing 44 rows.

In various embodiments, blocks are implemented in various ways. For example, in some embodiments, blocks are implemented as data structures that contain identifiers of rows (e.g., row “513,” row “234,” row “876,” etc.). In yet other embodiments, the blocks are data structures comprising copies of rows. Suitable data structures include linked lists, arrays, vectors, queues, stacks, or other types of data structures.

After dividing the rows in spreadsheet table into the set of blocks, the spreadsheet application 108 determines an appropriate number of block sorting threads for the spreadsheet table (312). In various embodiments, the spreadsheet application 108 determines an appropriate number of block sorting threads in various ways. For example, in some embodiments, if the number of blocks is less than or equal to the number of the processing units 110 in the processing system 104, the spreadsheet application 108 determines that the appropriate number of block sorting threads is equal to the number of blocks. If the number of blocks is greater than the number of the processing units 110 in the processing system 104, the spreadsheet application 108 determines that the appropriate number of block sorting threads is equal to the number of the processing units 110 in the processing system 104. In some embodiments, the spreadsheet application 108 presents a user interface that allows an administrative user to set the appropriate number of block sorting threads.

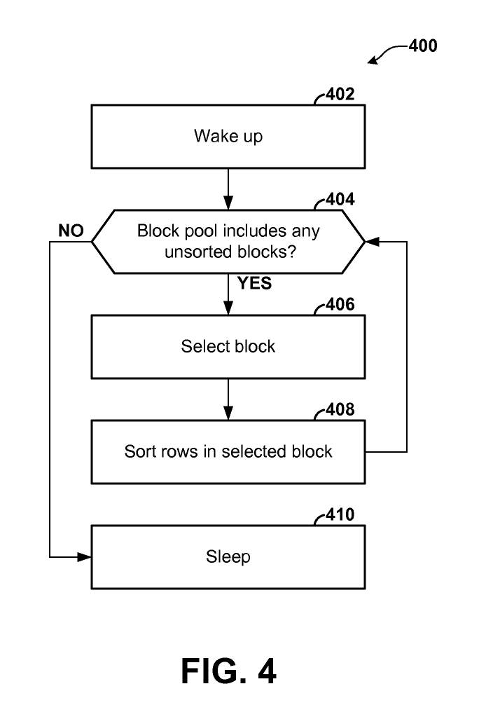

After determining the appropriate number of block sorting threads, the spreadsheet application 108 begins a block sorting phase of the sort process. During the block sorting phase of the sort process, the spreadsheet application 108 uses the appropriate number of block sorting threads to sort the rows in the blocks (314). In some instances, each of the block sorting threads executes in parallel on a different one of the processing units 110 in the processing system 104. Each of the block sorting threads selects unsorted blocks and sorts the rows in the selected blocks. This continues until the rows in each of the blocks are properly ordered. FIG. 4, described in detail elsewhere in this document, illustrates an example operation performed by each of the block sorting threads.

After the block sorting threads finish sorting the blocks, the block sorting phase of the sort process ends and a merging phase of the sort process begins. During the merging phase of the sort process, the spreadsheet application 108 uses a min merge thread and a max merge thread to merge the blocks into a single final block (316). The final block includes all of the rows of the spreadsheet table. The rows in the final block are properly ordered. The min merge thread and the max merge thread are able to operate in parallel on different ones of the processing units 110 in the processing system 104. The spreadsheet application 108 provides to the min merge thread and the max merge thread references to the set of sorted blocks.

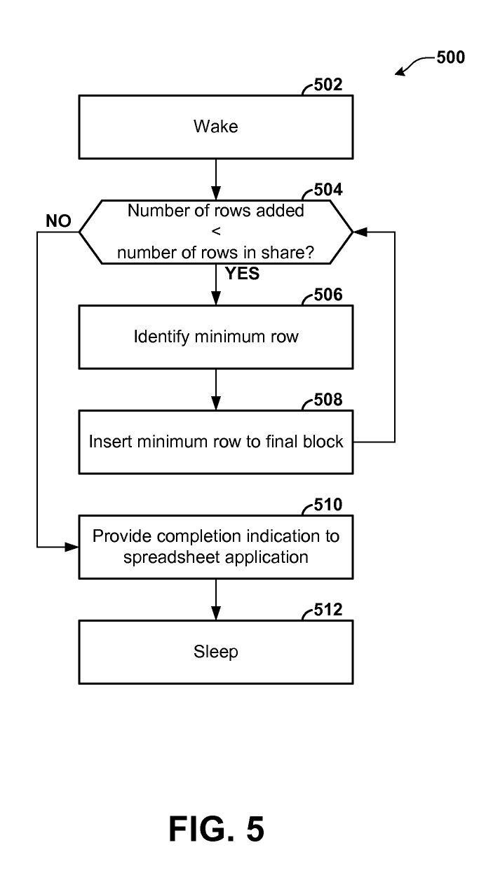

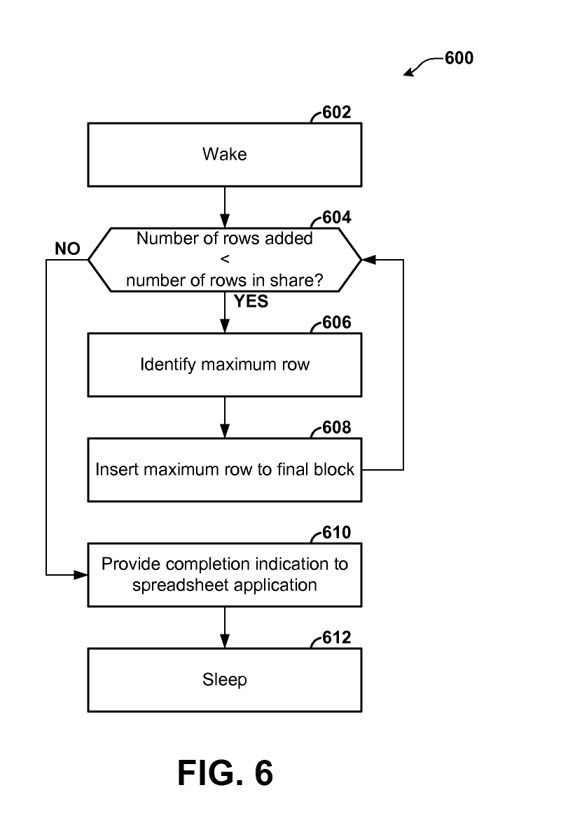

To merge the sorted blocks into the single final block, the min merge thread operates to progressively insert the smallest remaining rows in the sorted blocks into the final block. The max merge thread operates to progressively insert the largest remaining rows in the sorted blocks into the final block. A row is considered to be “remaining” when the row is not in the final block. The smallest remaining row is the row that would be listed first if all of the remaining rows in the sorted blocks were properly ordered for a current sort-by column. The largest remaining row is the row that would be listed last if all of the remaining rows in the blocks were properly ordered for the current sort-by column FIG. 5, described in detail elsewhere in this document, illustrates an example operation performed by the min merge thread to progressively insert the smallest remaining rows in the sorted blocks into the final block. FIG. 6, described in detail elsewhere in this document, illustrates an example operation performed by the max merge thread to progressively insert the largest remaining rows in the sorted blocks into the final block.

After the min merge thread and the max merge thread merge the sorted blocks into the final block in step 316 or after the rows are sorted in step 306, the spreadsheet application 108 returns the final block (318).

FIG. 4 is a flowchart illustrating an example operation 400 performed by a block sorting thread to sort one or more blocks. Although the operation 400 is described herein as being performed by a single block sorting thread, each thread involved in the block sorting phase of the sort process for a spreadsheet table performs the operation 400 concurrently.

As illustrated in the example of FIG. 4, the operation 400 begins when a block sorting thread is woken by the spreadsheet application 108 (402). Waking a thread is the process of getting a thread ready to be run. When the spreadsheet application 108 wakes the block sorting thread, the spreadsheet application 108 provides a block pool identifier to the block sorting thread. The block pool indicator identifies a block pool for a spreadsheet table. The block pool is a set of blocks containing rows in a spreadsheet table. The block sorting thread uses the block pool identifier to access the block pool.

In various embodiments, the spreadsheet application 108 can wake the block sorting thread in various ways. For example, in some embodiments, the spreadsheet application 108 maintains a pool of threads that are capable of acting as block sorting threads. Available threads in the pool have been started, but are asleep. In this example, the spreadsheet application 108 selects threads in the pool of threads to act as block sorting threads and provides wake events to the selected threads. In other embodiments, the spreadsheet application 108 can wake the block sorting thread by creating a new thread capable of performing the operation 400.

After the block sorting thread wakes, the block sorting thread determines whether the block pool includes any unsorted blocks (404). In various embodiments, the block sorting thread can determine whether the block pool includes any unsorted blocks in various ways. For example, in some embodiments, the spreadsheet application 108 maintains a data structure containing a flag corresponding to each block in the block pool. The flag corresponding to a block has one value when the block has been sorted and another value when the block has not yet been sorted. Each block sorting thread involved in the block sorting phase of the sort process for the spreadsheet table uses this data structure to determine whether the block pool includes any unsorted blocks. In other embodiments, block sorting threads move blocks from a first buffer to a second buffer when the block sorting threads sort the blocks. In such embodiments, the block sorting threads determine whether the block pool includes any unsorted blocks by determining whether the first buffer includes any blocks.

If the block pool includes any unsorted blocks (“YES” of 404), the block sorting thread selects one of the unsorted blocks in the block pool (406). Each block sorting thread involved in the sort process for the spreadsheet table selects unsorted blocks from the same block pool. When the block sorting thread selects a block, no other block sorting thread selects that block. For example, a first block sorting thread and a second block sorting thread are involved in the sort process for the spreadsheet table and the block pool for the spreadsheet table includes blocks “A,” “B,” and “C.” In this example, the first block sorting thread can select the block “A” and the second block sorting thread can select the block “B.” In this example, after the first block sorting thread selects the block “A,” the second block sorting thread cannot select the block “A,” even if the first block sorting thread has not finished sorting the block “A.”

In various embodiments, the block sorting thread selects one of the unsorted blocks from the block pool in various ways. For example, in some embodiments, the block sorting thread selects one of the unsorted blocks on a pseudorandom basis. In other embodiments, the block sorting thread selects one of the unsorted blocks based on an order of the blocks in the block pool.

Next, the block sorting thread sorts the rows in the selected block (408). The block sorting thread sorts the rows in the selected block according to the ordering relationship over the relevant property in the sort-by column of the rows in the selected block. In various embodiments, the block sorting thread sorts the rows in the selected block in various ways. For example, in some embodiments, the block sorting thread uses a bubble sort algorithm to sort the rows in the selected block. In another example, the block sorting thread uses a quick sort algorithm (e.g., qsort) to sort the rows in the selected block. In yet another example, the block sorting thread uses a merge sort algorithm to sort the rows in the selected block. In various embodiments, the block sorting thread performs various actions to indicate that the selected block has been sorted. For example, the spreadsheet application 108 maintains a data structure containing a flag corresponding to each block in the block pools. In this example, the block sorting thread changes a value of flag corresponding to the selected block after the block sorting thread has sorted the rows in the selected block.

After sorting the rows in the selected block, the block sorting thread again determines whether there are any unsorted blocks in the block pool (404). As long as there are unsorted blocks in the block pool, the block sorting thread continues to select and sort blocks in the block pool. If there are no unsorted blocks in the block pool (“NO” of 404), the block sorting thread goes to sleep (410). When the block sorting thread goes to sleep, the block sorting thread enters an inactive state. Subsequently, the spreadsheet application 108 can reawaken the block sorting thread and instruct the block sorting thread to perform the operation 400 with regard to a block pool for another spreadsheet table. In alternate embodiments, the block sorting thread is terminated when there are no unsorted blocks in the block pool.

FIG. 5 is a flowchart illustrating an example operation 500 performed by a min merge thread to insert the smallest remaining rows in a set of sorted blocks into a final block. As illustrated in the example of FIG. 5, the operation 500 begins when the min merge thread is woken by the spreadsheet application 108 (502). In various embodiments, the spreadsheet application 108 wakes the min merge thread in various ways. For example, in some embodiments, the spreadsheet application 108 maintains references to sleeping threads that are able to perform the operation 500. In some embodiments, the sleeping threads can include the block sorting threads used in the block sorting phase of the sort process. In other words, one of the block sorting threads can act as the min merge thread. In other embodiments, the spreadsheet application 108 only maintains a single thread capable of performing the operation 500. To wake the min merge thread, the spreadsheet application 108 provides a wake event to a thread that can perform the operation 500 and provides to the min merge thread a reference to the set of sorted blocks.

In various embodiments, the min merge thread performs various actions when the min merge thread wakes. For example, in some embodiments, the min merge thread constructs a red-black tree when the min merge thread wakes. A red-black tree is a particular type of binary search tree. A binary search tree is a node-based binary tree data structure which has the following properties: (1) for each node in the binary search tree, nodes in the left subtree of the node have values smaller than the value of the node; (2) for each node in the binary search tree, nodes in the right subtree of the node have values larger than the value of the node; and (3) for each node in the binary search tree, the left subtree of the node and the right subtree of the node are also binary search trees. A red-black tree is a binary search tree that satisfies the following additional requirements: (1) each node is conceptually either red or black; (2) the root node is black; (3) all leaf nodes are black; (4) both child nodes of every red node are black; and (5) every simple path from a given node to any of the node's descendant leaf nodes contains the same number of black nodes. In this example, the min merge thread constructs the red-black tree such that each node in the red-black tree corresponds to the smallest remaining row in each of the blocks. For example, if there are three blocks, the relevant property is the value in the cells in the sort-by column, and the smallest remaining rows in the blocks have values 5, 34, and 10, the min merge thread constructs the red-black tree such that the red-black tree has a node corresponding to 5, a node corresponding to 34, and a node corresponding to 10.

After the min merge thread wakes, the min merge thread determines whether the number of rows added to the final block by the min merge thread is less than the number of rows in the min merge thread's share of the rows in the sorted blocks (504). In various embodiments, the min merge thread has various shares of the rows in the sorted blocks. For example, in some embodiments, if there is an even number of rows in the sorted blocks, the number of rows in the min merge thread's share is equal to the total number of rows in the sorted blocks divided by two. In this example, if there are an odd number of rows in the sorted blocks, the number of rows in the min merge thread's share is equal to the total number of rows in the sorted block divided by two, rounded down, plus one. In this example, if there are an odd number of rows in the sorted blocks, the number of rows in the max merge thread's share is equal to the total number of rows in the sorted block divided by two, rounded down. Hence, in this example, where there are an odd number of rows, the min merge thread adds one more row to the final block than the max merge thread. In other embodiments, if there are an odd number of rows in the sorted blocks, the max merge thread adds one more row to the final block than the min merge thread.

If the number of rows added to the final block by the min merge thread is less than the number of rows in the min merge thread's share of the rows in the sorted blocks (“NO” of 504), the min merge thread identifies a minimum row (506). The minimum row is the smallest remaining row of all of the remaining rows in the sorted blocks (i.e., the smallest row of all the rows in the sorted blocks that is not in the final block).

As discussed above, in some embodiments, multiple sort-by columns can be selected. For example, a user can indicate that the spreadsheet table should first be sorted on a “city” column and then on a “date” column. If there are multiple sort-by columns and if the relevant properties in cells in the highest ranked sort-by column of two rows are the same, the min merge thread identifies the minimum row by comparing the relevant properties in cells in the next highest rankest sort-by column of the two rows. If the relevant properties of cells in the next highest ranked sort-by column are the same, the min merge thread identifies the minimum row by comparing the relevant properties in cells of the third highest ranked sort-by column of the two rows. This comparison process continues until there are either no more sort-by columns or until the min merge thread identifies one of the rows as being smaller than the other row. If the relevant properties of cells in all sort-by columns of the two rows are equal, the min merge thread can identify either of the rows as the minimum row.

In various embodiments, the min merge thread identifies the minimum row in various ways. For example, in some embodiments, the min merge thread maintains a red-black tree as described above. In this example, the row corresponding to the leftmost node in the red-black tree is the smallest row that is not already in the final block (i.e., the minimum row).

In other embodiments, the min merge thread and the max merge thread maintain index values for each of the sorted blocks, as described above. In such embodiments, the min merge thread scans through the rows that are immediately greater than the rows indicated by each of the min merge thread's index values and that are not indicated by any of the max merge thread's index values. The smallest such row is the smallest remaining row in the sorted blocks.

After identifying the minimum row, the min merge thread inserts the minimum row into the final block (508). The min merge thread inserts the minimum row into the final block in such a way that the rows in the final block remain properly ordered. In various embodiments, the min merge thread inserts the minimum row into the final block in various ways. For example, in some embodiments, the final block comprises a min final block and a max final block. The min merge thread generates the min final block by progressively inserting the smallest remaining rows in the sorted blocks into the large end of the min merge list. The max merge thread generates the max final block by progressively inserting the largest remaining rows in the sorted blocks into the small end of the max merge list. In this example, the spreadsheet application 108 generates the final block when there are no remaining rows in the sorted blocks by concatenating the max final block to the large end of the min final block. In another example, the final block is a single data structure. A pointer indicates a middle of the data structure. The min merge thread inserts rows on one side of the pointer and the max merge thread inserts rows on the other side of the pointer. In this way, the final block grows from the middle outward. In yet another example, the min merge thread and the max merge thread assign ordering indexes to the rows. The ordering index of a row indicates the position of the data item in the final block. For instance, the min merge thread could assign an ordering index of “12” to a row to indicate that the row is in the twelfth position in the final block.

In embodiments that use the red-black tree described above, the min merge thread performs several actions to maintain the red-black tree after the min merge thread inserts the minimum row into the min final block. Initially, the min merge thread removes the leftmost node from the red-black tree and reformulates the red-black tree such that the red-black tree remains a proper red-black tree. The min merge thread adds to the red-black tree a node corresponding to the new smallest row in the sorted block that contained the minimum row. In some embodiments, the min merge thread maintains pointers to each of the smallest remaining rows in the sorted blocks. Use of such pointers can increase the efficiency of finding the new smallest remaining row.

In embodiments that use the index values described above, the min merge thread can perform several actions to maintain the index values after the min merge thread inserts the minimum row into the min final block. For instance, the min merge thread can advance the min merge thread's index value for the sorted block containing the minimum row such that the min merge thread's index value for this sorted block indicates the minimum row.

After inserting the minimum row into the final block, the min merge thread again determines whether the number of rows added to the final block by the min merge thread is less than the number of rows in the min merge thread's share of the rows in the sorted blocks (504). If the number of rows added to the final block by the min merge thread is less than the number of rows in the min merge thread's share of the rows in the sorted blocks (“YES” of 504), the min merge thread performs the steps 506 and 508 with regard to a new minimum row, and so on. If number of rows added to the final block by the min merge thread is not less than the number of rows in the min merge thread's share of the rows in the sorted blocks (“NO” of 504), the min merge thread provides a completion indication to the spreadsheet application 108 (510). The min merge thread then goes back to sleep (512).

FIG. 6 is a flowchart illustrating an example operation 600 performed by a max merge thread to insert the largest remaining rows in a set of sorted blocks into a final block. As illustrated in the example of FIG. 6, the operation 600 begins when the max merge thread is woken by the spreadsheet application 108 (602). In various embodiments, the spreadsheet application 108 wakes the max merge thread in various ways. For example, in some embodiments, the spreadsheet application 108 maintains references to sleeping threads that are able to perform the operation 600. In some embodiments, the sleeping threads can include the block sorting threads. In other words, one of the block sorting threads can act as the max merge thread. In other embodiments, the spreadsheet application 108 only maintains a single thread capable of performing the operation 600. To wake the max merge thread, the spreadsheet application 108 provides a wake event to a thread that can perform the operation 600. In addition, the spreadsheet application 108 provides to the max merge thread a reference to the set of sorted blocks.

In various embodiments, the max merge thread can perform various actions when the max merge thread wakes. For example, in some embodiments, the max merge thread constructs a red-black tree when the max merge thread wakes. The max merge thread constructs the red-black tree such that the red-black tree contains nodes corresponding to the largest remaining rows in the sorted blocks.

After the max merge thread wakes, the max merge thread determines whether number of rows added to the final block by the max merge thread is less than the number of rows in the max merge thread's share of the rows in the sorted blocks (604). If the number of rows added to the final block by the max merge thread is less than the number of rows in the max merge thread's share of the rows in the sorted blocks (“NO” of 604), the max merge thread identifies a maximum row (606). The maximum row is the largest row in any of the sorted blocks that is not already in the final block (i.e., the largest remaining row in any of the blocks).

As discussed above, in some embodiments, multiple sort-by columns can be selected. If there are multiple sort-by columns and if the relevant properties in cells in the highest ranked sort-by column of two rows are the same, the max merge thread identifies the maximum row by comparing the relevant properties in cells in the next highest rankest sort-by column of the two rows. If the relevant properties of cells in the next highest ranked sort-by column are the same, the max merge thread identifies the maximum row by comparing the relevant properties in cells of the third highest ranked sort-by column of the two rows. This comparison process continues until there are either no more sort-by columns or until the max merge thread identifies one of the rows as being larger than the other row. If the relevant properties of cells in all sort-by columns of the two rows are equal, the max merge thread can identify either of the rows as the maximum row.

In various embodiments, the max merge thread identifies the maximum row in various ways. For example, in embodiments where the max merge thread maintains the red-black tree as described above, the max merge thread maintains a red-black tree such that the red-black tree contains a node corresponding to the largest row in each of the sorted blocks. In this example, the rightmost node in the red-black tree corresponds to the maximum row.

In other embodiments, the max merge thread and the min merge thread maintain index values for each of the sorted blocks, as described above. In such embodiments, the max merge thread scans through the rows that are immediately smaller than the rows indicated by the max merge thread's index values and that are not indicated by any of the min merge thread's index values. The largest such row is the largest remaining row in the sorted blocks.

After identifying the maximum row, the max merge thread inserts the maximum row into the final block (608). The max merge thread inserts the maximum row into the final block in such a way that the rows in the final block remain properly ordered. In various embodiments, the max merge thread inserts the maximum row into the final block in various ways. For example, the max merge thread can insert the maximum row into the final block in ways similar to those used by the min merge thread to insert the minimum row into the final block.

In embodiments that use the red-black tree described above, the max merge thread performs several actions to maintain the red-black tree after the max merge thread inserts the maximum row into the final block. Initially, the max merge thread removes the rightmost node from the red-black tree and reformulates the red-black tree such that the red-black tree remains a proper red-black tree. The max merge thread then adds to the red-black tree a node corresponding to the new largest row in the sorted block that contained the maximum row. In some embodiments, the max merge thread maintains pointers to each of the largest remaining rows in the sorted blocks. Use of such pointers can increase the efficiency of finding the new largest remaining row.

After inserting the maximum row into the final block, the max merge thread again determines whether the number of rows added to the final block by the max merge thread is less than the number of rows in the max merge thread's share of the rows in the sorted blocks (604). If the number of rows added to the final block by the min merge thread is less than the number of rows in the min merge thread's share of the rows in the sorted blocks (“YES” of 504), the max merge thread repeats steps 606 and 608 with regard to a new maximum row. If the number of rows added to the final block by the min merge thread is not less than the number of rows in the min merge thread's share of the rows in the sorted blocks (“NO” of 604), the max merge thread provides a completion indication to the spreadsheet application 108 (610). The max merge thread then goes to sleep (612).

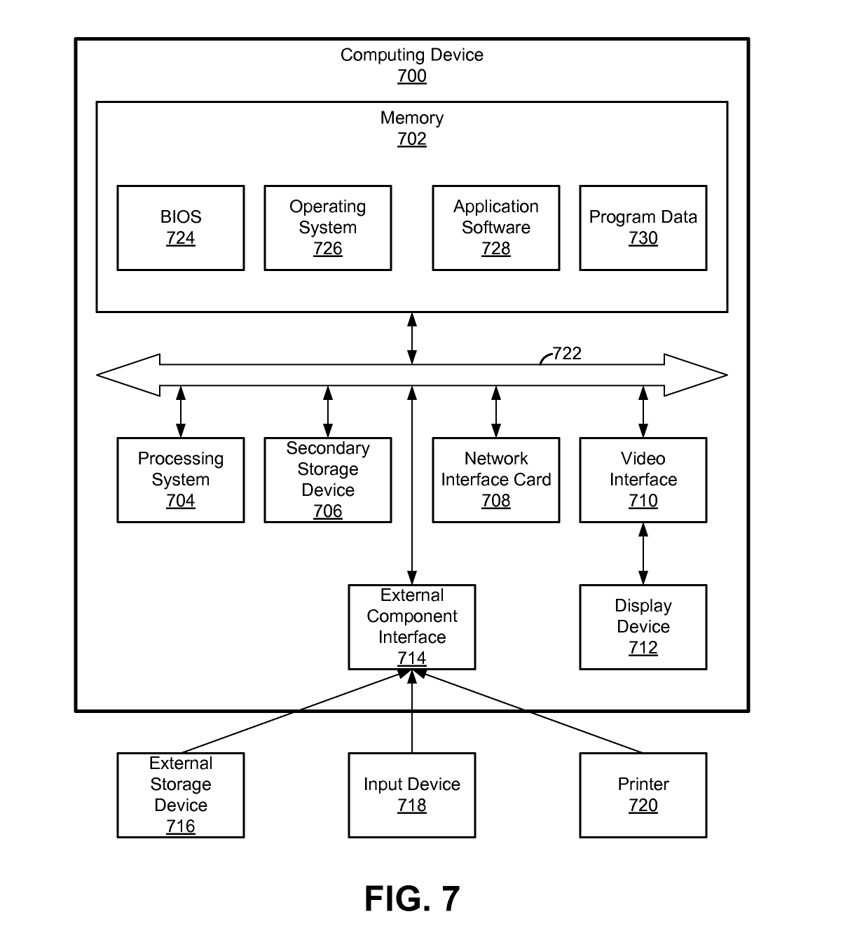

FIG. 7 is a block diagram illustrating an example computing device 700. In some embodiments, the computing system 100 is implemented using one or more computing devices like the computing device 700. It should be appreciated that in other embodiments, the computing system 100 is implemented using computing devices having hardware components other than those illustrated in the example of FIG. 7.

In different embodiments, computing devices are implemented in different ways. For instance, in the example of FIG. 7, the computing device 700 comprises a memory 702, a processing system 704, a secondary storage device 706, a network interface card 708, a video interface 710, a display device 712, an external component interface 714, an external storage device 716, an input device 718, a printer 720, and a communication medium 722. In other embodiments, computing devices are implemented using more or fewer hardware components. For instance, in another example embodiment, a computing device does not include a video interface, a display device, an external storage device, or an input device.

The memory 702 includes one or more computer-readable data storage media capable of storing data and/or instructions. A computer-readable data storage medium is a device or article of manufacture that stores data and/or software instructions readable by a computing device. In different embodiments, the memory 702 is implemented in different ways. For instance, in various embodiments, the memory 702 is implemented using various types of computer-readable data storage media. Example types of computer-readable data storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data.

The processing system 704 includes one or more physical integrated circuits that selectively execute software instructions. In various embodiments, the processing system 704 is implemented in various ways. For instance, in one example embodiment, the processing system 704 is implemented as one or more processing cores. For instance, in this example embodiment, the processing system 704 may be implemented as one or more Intel Core 2 microprocessors. In another example embodiment, the processing system 704 is implemented as one or more separate microprocessors. In yet another example embodiment, the processing system 704 is implemented as an ASIC that provides specific functionality. In yet another example embodiment, the processing system 704 provides specific functionality by using an ASIC and by executing software instructions.

In different embodiments, the processing system 704 executes software instructions in different instruction sets. For instance, in various embodiments, the processing system 704 executes software instructions in instruction sets such as the x86 instruction set, the POWER instruction set, a RISC instruction set, the SPARC instruction set, the IA-64 instruction set, the MIPS instruction set, and/or other instruction sets.

The secondary storage device 706 includes one or more computer-readable data storage media. The secondary storage device 706 stores data and software instructions not directly accessible by the processing system 704. In other words, the processing system 704 performs an I/O operation to retrieve data and/or software instructions from the secondary storage device 706. In various embodiments, the secondary storage device 706 is implemented by various types of computer-readable data storage media. For instance, the secondary storage device 706 may be implemented by one or more magnetic disks, magnetic tape drives, CD-ROM discs, DVD-ROM discs, Blu-Ray discs, solid state memory devices, Bernoulli cartridges, and/or other types of computer-readable data storage media.

The network interface card 708 enables the computing device 700 to send data to and receive data from a computer communication network. In different embodiments, the network interface card 708 is implemented in different ways. For example, in various embodiments, the network interface card 708 is implemented as an Ethernet interface, a token-ring network interface, a fiber optic network interface, a wireless network interface (e.g., WiFi, WiMax, etc.), or another type of network interface.

The video interface 710 enables the computing device 700 to output video information to the display device 712. In different embodiments, the video interface 710 is implemented in different ways. For instance, in one example embodiment, the video interface 710 is integrated into a motherboard of the computing device 700. In another example embodiment, the video interface 710 is a video expansion card. Example types of video expansion cards include Radeon graphics cards manufactured by ATI Technologies, Inc. of Markham, Ontario, Geforce graphics cards manufactured by Nvidia Corporation of Santa Clara, Calif., and other types of graphics cards.

In various embodiments, the display device 712 is implemented as various types of display devices. Example types of display devices include, but are not limited to, cathode-ray tube displays, LCD display panels, plasma screen display panels, touch-sensitive display panels, LED screens, projectors, and other types of display devices. In various embodiments, the video interface 710 communicates with the display device 712 in various ways. For instance, in various embodiments, the video interface 710 communicates with the display device 712 via a Universal Serial Bus (USB) connector, a VGA connector, a digital visual interface (DVI) connector, an S-Video connector, a High-Definition Multimedia Interface (HDMI) interface, a DisplayPort connector, or other types of connectors.

The external component interface 714 enables the computing device 700 to communicate with external devices. In various embodiments, the external component interface 714 is implemented in different ways. For instance, in one example embodiment, the external component interface 714 is a USB interface. In other example embodiments, the computing device 700 is a FireWire interface, a serial port interface, a parallel port interface, a PS/2 interface, and/or another type of interface that enables the computing device 700 to communicate with external components.

In different embodiments, the external component interface 714 enables the computing device 700 to communicate with different external components. For instance, in the example of FIG. 7, the external component interface 714 enables the computing device 700 to communicate with the external storage device 716, the input device 718, and the printer 720. In other embodiments, the external component interface 714 enables the computing device 700 to communicate with more or fewer external components. Other example types of external components include, but are not limited to, speakers, phone charging jacks, modems, media player docks, other computing devices, scanners, digital cameras, a fingerprint reader, and other devices that can be connected to the computing device 700.

The external storage device 716 is an external component comprising one or more computer readable data storage media. Different implementations of the computing device 700 interface with different types of external storage devices. Example types of external storage devices include, but are not limited to, magnetic tape drives, flash memory modules, magnetic disk drives, optical disc drives, flash memory units, zip disk drives, optical jukeboxes, and other types of devices comprising one or more computer-readable data storage media. The input device 718 is an external component that provides user input to the computing device 700. Different implementations of the computing device 700 interface with different types of input devices. Example types of input devices include, but are not limited to, keyboards, mice, trackballs, stylus input devices, key pads, microphones, joysticks, touch-sensitive display screens, and other types of devices that provide user input to the computing device 700. The printer 720 is an external device that prints data to paper. Different implementations of the computing device 700 interface with different types of printers. Example types of printers include, but are not limited to laser printers, ink jet printers, photo printers, copy machines, fax machines, receipt printers, dot matrix printers, or other types of devices that print data to paper.

The communications medium 722 facilitates communication among the hardware components of the computing device 700. In different embodiments, the communications medium 722 facilitates communication among different components of the computing device 700. For instance, in the example of FIG. 7, the communications medium 722 facilitates communication among the memory 702, the processing system 704, the secondary storage device 706, the network interface card 708, the video interface 710, and the external component interface 714. In different implementations of the computing device 700, the communications medium 722 is implemented in different ways. For instance, in different implementations of the computing device 700, the communications medium 722 may be implemented as a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computing system Interface (SCSI) interface, or another type of communications medium.

The memory 702 stores various types of data and/or software instructions. For instance, in the example of FIG. 7, the memory 702 stores a Basic Input/Output System (BIOS) 724, an operating system 726, application software 728, and program data 730. The BIOS 724 includes a set of software instructions that, when executed by the processing system 704, cause the computing device 700 to boot up. The operating system 726 includes a set of software instructions that, when executed by the processing system 704, cause the computing device 700 to provide an operating system that coordinates the activities and sharing of resources of the computing device 700. Example types of operating systems include, but are not limited to, Microsoft Windows®, Linux, Unix, Apple OS X, Apple OS X iPhone, Palm webOS, Palm OS, Google Chrome OS, Google Android OS, and so on. The application software 728 includes a set of software instructions that, when executed by the processing system 704, cause the computing device 700 to provide applications to a user of the computing device 700. The program data 730 is data generated and/or used by the application software 728.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can the steps of the operations shown in the figures in different orders.

We claim:

1. A method comprising:
dividing, by a computing system, data items in a spreadsheet table into a plurality of blocks;
using multiple threads to sort the data items in the blocks;
after sorting the data items in the blocks, using multiple threads to merge the blocks into a final block, the final block containing each of the data items in the spreadsheet table; and
displaying a sorted version of the spreadsheet table in which data items in the spreadsheet table have the same order as an order of data items in the final block.

2. The method of claim 1, further comprising:
determining an appropriate block size based on a number of data items in the spreadsheet table; and
wherein the data items in the spreadsheet table are divided into the plurality of blocks such that none of the blocks contains more data items than the appropriate block size and only one of the blocks is allowed to contain fewer data items than the appropriate block size.

3. The method of claim 2, wherein determining the appropriate block size comprises determining that the appropriate block size is a given size when the total number of data items in the spreadsheet table is greater than one threshold and less than or equal to another threshold.

4. The method of claim 1, wherein the data items in the final block are properly ordered for multiple sort-by columns.

5. The method of claim 1, further comprising:
determining whether a total number of data items in the spreadsheet table exceeds a lower limit; and
using a single thread to sort the data items in the spreadsheet table when the total number of data items in the spreadsheet table does not exceed the lower limit.

6. The method of claim 1,
wherein the method further comprises: prior to sorting the data items in the blocks, determining an appropriate number of block sorting threads for the spreadsheet table;
wherein using multiple threads to sort the data items in the blocks comprises using the appropriate number of block sorting threads to sort the data items in the blocks;
wherein the appropriate number of block sorting threads is equal to a number of the blocks when the number of the blocks is less than or equal to a number of processing units in a processing system,
wherein the appropriate number of block sorting threads is equal to the number of processing units in the processing system when the number of blocks is greater than or equal to the number of processing units in the processing system.

7. The method of claim 6, further comprising: presenting a user interface that allows an administrative user to set the appropriate number of block sorting threads.

8. The method of claim 1, wherein using multiple threads to sort the data items in the blocks comprises using a merge sort algorithm to sort the data items in the blocks.

9. The method of claim 1, wherein using multiple threads to merge the blocks into the final block comprises:
waking a min merge thread that progressively inserts smallest data items in the sorted blocks into the final block; and
waking a max merge thread that progressively inserts largest data items in the sorted blocks into the final block.

10. The method of claim 9,
wherein the min merge thread uses a first red-black tree to identify the smallest data items in the sorted blocks; and
wherein the max merge thread uses a second red-black tree to identify the largest data items in the sorted blocks.

11. The method of claim 9, wherein the min merge thread and the max merge thread operate concurrently.

12. The method of claim 1, wherein displaying the sorted version of the spreadsheet table comprises: sending result data to a client device via a network, the client device configured to process the result data for presentation of the sorted version of the spreadsheet table to a user.

13. The method of claim 1, wherein the multiple threads used to sort the data items in the blocks operate concurrently.

14. A computing system comprising:
a processing system that comprises a plurality of processing units; and
a data storage system that stores computer-readable instructions that, when executed by one or more of the processing units, cause the computing system to:
divide the data items in a spreadsheet table into a plurality of blocks;
use multiple threads to sort the data items in the blocks based on a relevant property of cells in a sort-by line of the spreadsheet table;
use multiple threads to merge the blocks into a final block, the final block containing each of the data items in the spreadsheet table; and
display a sorted version of the spreadsheet table in which data items in the spreadsheet table have the same order as an order of the data items in the final block.

15. The computing system of claim 14, wherein the computer-readable instructions, when executed by one or more of the processing units, cause the computing system to determine an appropriate block size based on the number of data items in the spreadsheet table, wherein none of the blocks has more data items than the appropriate block size.

16. The computing system of claim 14, wherein the computer-readable instructions, when executed by one or more of the processing units, further cause the computing system to determine an appropriate number of block sorting threads,
wherein the appropriate number of block sorting threads is equal to a number of the blocks when the number of the blocks is less than or equal to a number of the processing units in the processing system,
wherein the appropriate number of block sorting threads is equal to the number of processing units in the processing system when the number of blocks is greater than or equal to the number of processing units in the processing system, and
wherein the computing system uses the appropriate number of block sorting threads to sort the data items in the blocks.

17. The computing system of claim 14, wherein to use multiple threads to merge the blocks into the final block, the computer-readable instructions, when executed by one or more of the processing units, cause the computing system to:
wake a min merge thread that progressively inserts smallest data items in the sorted blocks into the final block; and
wake a max merge thread that progressively inserts largest data items in the sorted blocks into the final block.

18. The method of claim 17,
wherein the min merge thread uses a first red-black tree to identify the smallest data items in the sorted blocks; and
wherein the max merge thread uses a second red-black tree to identify the largest data items in the sorted blocks.

19. The computing system of claim 17,
wherein the min merge thread and the max merge thread operate concurrently; and
wherein the multiple threads used to sort the data items in the blocks operate concurrently.

20. A computer-readable data storage medium that stores computer-readable instructions that, when executed by one or more processing units in a processing system of a computing system, cause the computing system to:
determine whether a total number of data items in a spreadsheet table exceeds a lower limit;
when the total number of data items in the spreadsheet table does not exceed the lower limit, use a single thread to sort the data items in the spreadsheet table;
when the total number of data items in the spreadsheet table is equal to or exceeds the lower limit:
determine that an appropriate block size is a first size when the total number of data items in the spreadsheet table is greater than a first threshold and less than or equal to a second threshold;
determine that the appropriate block size is a second size when the total number of data items in the spreadsheet table is greater than the second threshold, the second size being larger than the first size;
divide the data items in the spreadsheet table into a plurality of blocks, none of the blocks containing more data items than the appropriate block size and only one of the blocks being allowed to contain fewer data items than the appropriate block size;
determine an appropriate number of block sorting threads for the spreadsheet table,
wherein the appropriate number of block sorting threads is equal to a number of the blocks when the number of the blocks is less than or equal to a number of the processing units in the processing system,
wherein the appropriate number of block sorting threads is equal to the number of processing units in the processing system when the number of blocks is greater than or equal to the number of processing units in the processing system,
use a plurality of block sorting threads to sort the data items in the blocks, the block sorting threads being equal in number to the appropriate number of block sorting threads; and
after the block sorting threads have sorted the data items in each of the blocks, use a min merge thread and a max merge thread to merge the data items in the blocks into a final block, the final block containing each of the data items in the spreadsheet table, the min merge thread progressively inserting smallest data items in the sorted blocks into the final block, the max merge thread progressively inserting largest data items in the sorted blocks into the final block; and
display a sorted version of the spreadsheet table in which data items in the spreadsheet table have the same order as an order of data items in the final block.
